(19) United States
(12) Patent Application Publication
(10) Pub. No.: US 2014/0149572 A1
(43) Pub. Date: May 29, 2014

(54) MONITORING AND DIAGNOSTICS IN COMPUTER NETWORKS

(71) Applicant: MICROSOFT CORPORATION, Redmond, WA (US)

(72) Inventors: Pascal Menezes, Bellevue, WA (US); Anthony Romano, Kirkland, WA (US); Bill Hanlon, Bellevue, WA (US); Gunter Leeb, Redmond, WA (US); Jon Morrow, Snoqualmie, WA (US)

(73) Assignee: MICROSOFT CORPORATION, Redmond, WA (US)

(21) Appl. No.: 13/686,918

(22) Filed: Nov. 28, 2012

(51) Int. Cl. H04L 12/26

(52) U.S. Cl. CPC H04L 43/00; H04L 67/14
USPC 709/224

(57) ABSTRACT

Various techniques of network monitoring and diagnostics in computer networks are disclosed herein. In one embodiment, a method includes configuring a network session between a first client device and a second client device interconnected to each other by the computer network. The configured network session having one or more encrypted attributes. The method also includes transmitting one or more of the encrypted attributes of the configured network session to a network management system for collecting information from one or more network elements connecting the first client device to the second client device during the network session.

### BACKGROUND

In computer networks, routers, gateways, and/or other types of network elements can typically inspect data traffic passing through. The inspection results can then be analyzed for quality-of-service control, intrusion detection, intrusion protection, firewalling, network monitoring, load balancing, and/or other suitable network management tasks. However, in some computer systems (e.g., unified communication systems), payloads of signaling and/or data traffic may be encrypted. The encryption can “blind” the various network elements, and thus impair execution of various network management tasks.

To address this difficulty, probes with heuristics may be deployed at different locations in a computer network to monitor and/or identify data traffic. However, deployment of such probes can be expensive, and monitoring results may be unreliable because accuracy depends not only on the number and locations of the deployed probes but also on precision of the heuristics.

### SUMMARY

The present technology is directed to monitoring network performance and diagnosing potential configuration and/or operation issues in computer networks, in which at least a portion of signaling and/or data traffic is encrypted. For example, in one aspect, a server can perform signaling between a first client device and a second client device to establish a network session (e.g., a video call) upon receiving a request. During signaling, various attributes of the network session may be established. The attributes can include network addresses and/or media access control (“MAC”) addresses of the first and second client devices, a media type, a required bandwidth of the network session, transport ports, transport protocols, codecs, session timestamps, encryption types, encryption keys, and/or other suitable session parameters.

The server can transmit one or more of the attributes in a decrypted form to a network management system. The network management system can then determine a network route having one or more network elements connecting the first client device to the second client device for the network session. Once the server indicates that the network session is started, the network management system can collect information of the one or more network elements periodically, on-demand, and/or in other suitable manners.

If a difficulty (e.g., a dropped call or bad call quality) arises during the network session, the server can notify the network management system of this occurrence. The network management system can then determine or at least estimate a potential cause of the difficulty by correlating and/or otherwise analyzing the collected information with respect to the difficulty. As a result, the network management system may determine whether the server and/or at least one of the network elements have potentially caused the difficulty. With such results, an operator and/or other management entities may quickly diagnose and resolve the difficulty.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a schematic diagram illustrating a computing framework in accordance with embodiments of the present technology.

FIG. 2 is a schematic block diagram illustrating computing components suitable for the server of FIG. 1 in accordance with embodiments of the present technology.

FIG. 3 is a block diagram showing computing components suitable for the network management system of FIG. 1 in accordance with embodiments of the present technology.

FIG. 4 is a block diagram showing software modules suitable for the process component of FIG. 3 in accordance with embodiments of the present technology.

FIG. 5 is a flow diagram illustrating a process for monitoring a computer network in accordance with embodiments of the present technology.

FIG. 6 is a flow diagram illustrating a process for performing diagnostics in a computer network in accordance with embodiments of the present technology.

### DETAILED DESCRIPTION

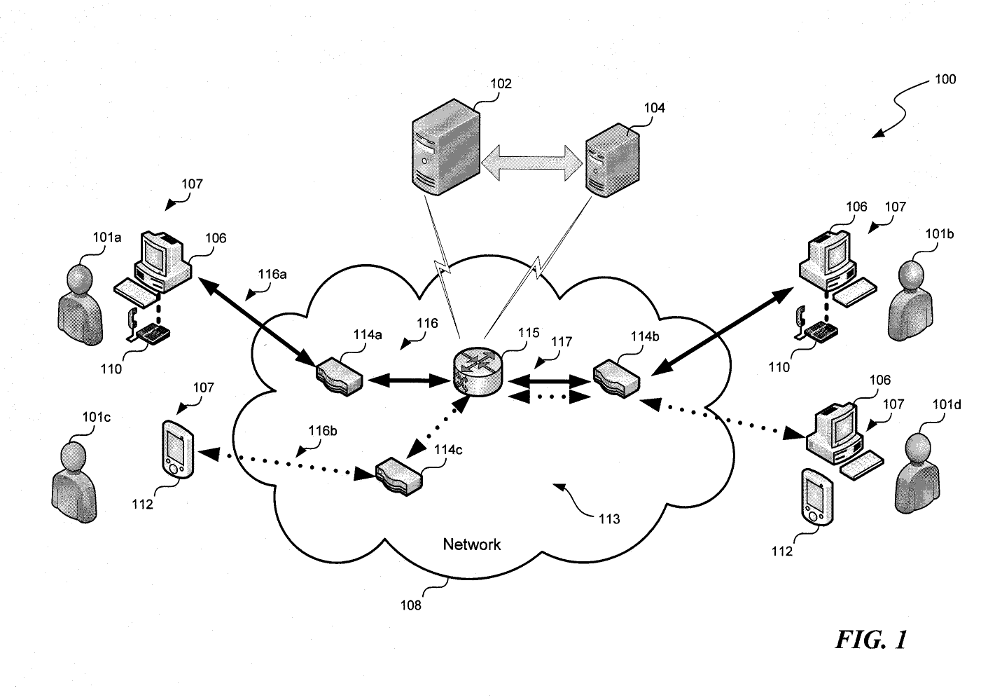

Various embodiments of systems, devices, components, modules, routines, and processes for monitoring and diagnostics in computer networks are described below. In the following description, example software codes, values, and other specific details are included to provide a thorough understanding of various embodiments of the present technology. A person skilled in the relevant art will also understand that the technology may have additional embodiments. The technology may also be practiced without several of the details of the embodiments described below with reference to FIGS. 1-6.

As used herein, the term “unified communication system” generally refers to an integrated system that combines real-time and non-real-time communication services. Examples of real-time communication services include instant messaging, presence information, telephony, video conferencing, application sharing, call control and speech recognition. Examples of non-real-time communication services can include voicemail, e-mail, short message service, webpage request, and facsimile. In certain embodiments, a unified communication system may be implemented in a single computer program/product. In other embodiments, a unified communication systems may be implemented in a set of computer programs/products that provide a unified user interface and/or experience across multiple devices and media types.

FIG. 1 is a schematic diagram illustrating a computing framework 100 in accordance with embodiments of the present technology. As shown in FIG. 1, the computing framework 100 can include a server 102, a network management system 104, and a plurality of client devices 107 interconnected to one another by a network 108. A plurality of users 101 (identified individually as first, second, third, and fourth users 101a, 101b, 101c, and 101d, respectively) may utilize corresponding client devices 107 to communicate and/or otherwise interact with one another. Even though only the foregoing components are illustrated in FIG. 1, in other embodiments, the computing framework 100 can also include additional servers, client devices, networking devices, and/or other suitable components.

The server 102 can be configured to facilitate processes by one or more of the client devices 107 to establish, update, or demolish a network session among the client devices 107. In one embodiment, the server 102 can include a unified communication system server (e.g., a Microsoft® Lync server). In other embodiments, the server 102 can include an enterprise server, a cloud server, an application server, a catalog server, a communication server, and/or other suitable types of server.

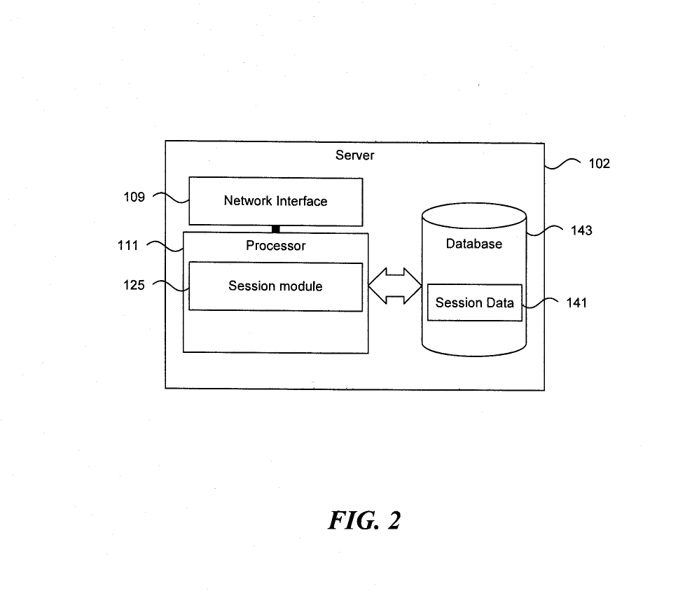

Even though the server 102 is illustrated in FIG. 1 as a single computing device, in certain embodiments, the server 102 may include one or more separate computing devices individually configured to perform at least one of registration, presence, and routing of network sessions, access to communication modes in client devices 107, rights management, audio/video conferencing, mediation to/from communication networks (e.g., publically switched telephone networks or cellular networks), and/or other suitable functions. In further embodiments, the server 102 may also be implemented as one or more virtual servers executed on computing device(s). Embodiments of computing components suitable for the server 102 are described in more detail below with reference to FIG. 2.

In the illustrated embodiment shown in FIG. 1, the client devices 107 can include different combinations of computers 106, telephones 110, and smart phones 112 configured to facilitate communication and/or other types of interaction with other users 101. For example, the first and second users 101a and 101b are each associated with a computer 106 and a telephone 110. The third user 101c is associated with a smart phone 112. The fourth user 101d is associated with a computer 106 and a smart phone 112. In other embodiments, the client devices 107 can also include laptop computers, tablet computers, automobile consoles, and/or other suitable computing devices configured for voice communication, video conferencing, instant messaging, application sharing, data sharing, and/or other suitable computer-implemented interactive activities.

The network 108 can include a plurality of network elements 113 interconnected to one another. For example, as shown in FIG. 1, the network 108 is illustrated as having a plurality of routers 114 (identified individually as first, second, and third routers 114a, 114b, and 114c, respectively) each connected to an Asynchronous Transfer Mode (“ATM”) router 115. The particular network elements 113 and arrangements of the network 108 in FIG. 1 are for illustration purposes only. In other embodiments, the network 108 can include other suitable network elements (not shown), arrangements, and/or network types. For example, in certain embodiments, the network 108 can be the Internet. In other embodiments, the network 108 can be a personal area network, a local area network, a storage area network, a backbone network, a Metropolitan area network, a wide area network, a virtual private network, and/or other suitable types of networks.

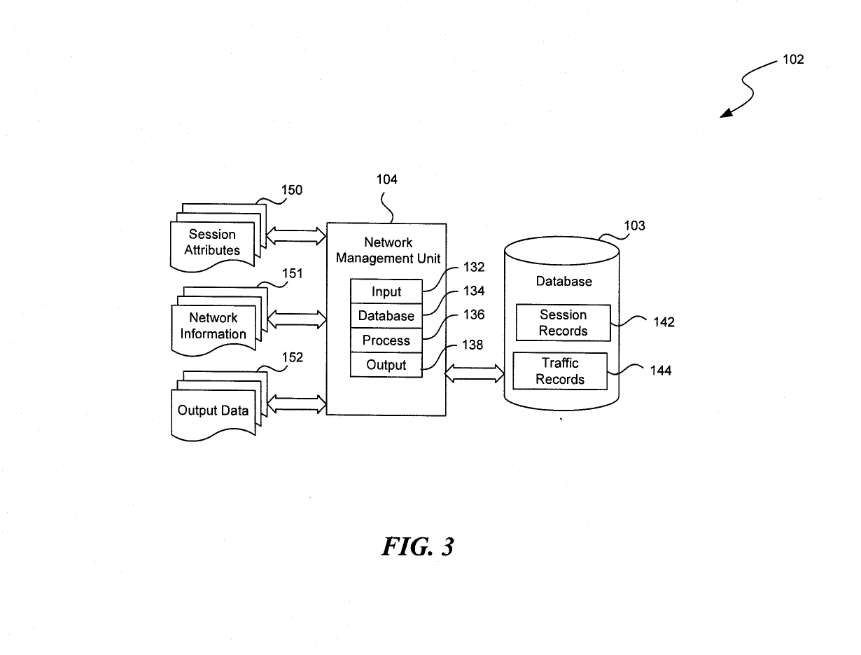

The network management system 104 is configured to receive, from the server 102, one or more of attributes of a network session between at least a pair of client devices 107. The network attributes can include combinations of network addresses of the client devices 107, a session identifier, a protocol of the session, source and destination transport ports, a media type of the network session, a codec, or a bandwidth estimation of the network session. At least one of the attributes is encrypted during establishment and/or configuration of the network session. The network management system 104 is then configured to collect information from one or more of the network elements 113 during the network session. The network management system 104 can then be configured to associate the collected information with the network session and diagnose potential issues with the server 102 and/or at least one of the network elements 113. Embodiments of computing components suitable for the network management system 104 are described in more detail below with reference to FIG. 3.

In operation, users 101 can transmit to the server 102 requests for network sessions with other users 101. For example, the first user 101a may request a first network session with the second user 101b. The third user 101c may request a second network session with the fourth user 101d. In response, the server 102 can signal and establish the requested network sessions following session initiation protocol (“SIP”) or other suitable protocols. The established network sessions can have a set of attributes including at least one of the following:
source/destination network addresses
a session identifier
a protocol of the network session
source and destination transport ports
a media type of the network session,
a codec,
a bandwidth estimation of the network session
encryption
encryption keys

One example of the set of attributes may be as follows:
IP SA & DA-SA 1.1.1.1 DA 2.2.2.2
MAC SA & DA-SA 48-2C-6A-1E-59-3D DA 65-1C-6B-3D-42-4B
Transport=TCP
Transport SP & DP=10000 and 10050
Switch (originating, intermediaries, destination)
Ports (originating, intermediaries, destination)
Media Type=Voice
Codex=G.711
Encryption=enabled
Encryption Key=864A1C4793BB246A
   As shown above, the set of attributes include network addresses (i.e., IP SA & DA), MAC address (i.e., MAC SA & DA), a transport protocol (i.e., TCP), transport ports (i.e., 10000 and 10050 for source and destination, respectively), switch and ports, a media type (i.e., Voice), an encryption setting (i.e., enabled), and an encryption key (i.e., 864A1C4793BB246A).

The server 102 can then “enlighten” the network management system 104 with at least some of the attributes of the established network sessions. For instance, in one embodiment, the server 102 can transmit the following set of attributes to the network management system 104 in a decrypted form:
Session Identifier=102
Session 5 Tuple=SA 1.1.1.1, DA 2.2.2.2, TCP, SP 10000, DP 10050
Action 1=QoS EF Queue
Action 2=Count
   As shown above, the transmitted attributes can include a session identifier (i.e., 102), a session 5-tuple that include a source address (i.e., SA 1.1.1.1), a destination address (i.e., DA 2.2.2.2), a session protocol (i.e., TCP), a source port (i.e., 10000), and a destination port (i.e., 10050). The example network session also involves two actions. Action 1 includes enforcement of quality of service (“QoS”) with expedited forwarding (“EF”) queue. Action 2 includes counting traffic flow (e.g., in number of packets) for the network session. In other embodiments, the server 102 can enlighten the network management system 104 with other suitable attributes in other suitable forms.

With the received attributes from the server 102, the network management system 104 can then construct a network route 116 for each of the requested first and second network sessions using interior gateway protocol (“IGP”) or other suitable protocols. For example, the first network session can have a first network route 116a (shown as solid arrows in FIG. 1) that includes the first router 114a, the ATM router 115, and the second router 114b. The second network session can have a second network route 116b (shown as dotted arrows in FIG. 1) that includes the third router 114c, the ATM router 115, and the second router 114b.

The network management system 104 can then collect configuration and/or operation parameters (collectively referred to as “network information”) from the network elements 113 along the first and second network routes 116a and 116b once a start notification is received from the server 102. Example configuration parameters can include network name, MAC address, port configuration, class of service, firmware version, security settings, forwarding settings, QoS settings, and/or other suitable parameters. Example operation parameters can include traffic throughput and class of service thereof, dropped packets, application level throughput (“goodput”), and/or other suitable operation information.

The network management system 104 can collect the network information periodically, on-demand, or in other suitable manners using simple network management protocol (“SNMP”) or other suitable protocols. In certain embodiments, the information collection period can be constant. In other embodiments, the information collection period may vary. For example, at the beginning of a network session, the information collection period may be long so to limit network traffic. As the network session progresses, the information collection period may be shortened. In other examples, the information collection period may be shortened if a performance degradation notification is received from the server 102, as discussed in more detail below.

The network management system 104 can continue collecting the network information until an end-of-session notification is received from the server 102 and/or based on other suitable criteria. During the network sessions, the network management system 104 can also receive update notifications from the server 102. The update notification may include indications that the users 101 have added a new mode of communication (e.g., voice, video, data, etc.) and certain attributes of the updated network session. In response, the network management system 104 can repeat the foregoing operations as if the updated network session is a new network session.

If the server 102 detects a performance degradation for network sessions, the server 102 may notify the network management system 104. In certain embodiments, the degradation notification can include at least some of the following information:
a timestamp of the performance degradation
source/destination network addresses
transport type
source/destination port
media type
bandwidth estimation
mean opinion score (“MOS”) degradation
jitter arrival time
packet loss rate
round trip delay
concealment ratio
   In other embodiments, the notification can also include other suitable information.

In response, the network management system 104 can associate a subset of the collected information with the network session and analyze for a potential cause of the performance degradation. For instance, in the example above, the network management system 104 may correlate packet loss rates of the routers 114 and the ATM router 115 to the timestamp of the performance degradation. As a result, the network management system 104 may determine that the packet loss rate between the ATM router 115 and the second router 114b is beyond an acceptable range (e.g., an upper threshold). As such, the network management system 104 may indicate that a congestion section 117 exists along the first and second network routes 116a and 116b.

In another example, the network management system 104 may correlate a configuration parameter (e.g., class of service) to the timestamp of the performance degradation. As a result, the network management system 104 may identify that the ATM router 115 is not configured properly for video, voice, or other types of service. In further embodiments, the network management system 104 may correlate both the configuration and operation parameters of the network 108 to determine a potential cause of the performance degradation. If a potential cause is identified, the network management system 104 may alert an operation and/or other suitable entity for further diagnosing and/or resolving the difficulty.

FIG. 2 is a schematic block diagram illustrating computing components suitable for the server 102 of FIG. 1 in accordance with embodiments of the present technology. In FIG. 2 and in other Figures herein, individual software components, modules, and routines may be a computer program, procedure, or process written as source code in C, C++, Java, and/or other suitable programming languages. The computer program, procedure, or process may be compiled into object or machine code and presented for execution by a processor of a personal computer, a network server, a laptop computer, a smart phone, and/or other suitable computing devices. Various implementations of the source and/or object code and associated data may be stored in a computer memory that includes read-only memory, random-access memory, magnetic disk storage media, optical storage media, flash memory devices, and/or other suitable storage media excluding propagated signals.

As shown in FIG. 2, the server 102 can include a network interface 109, a server processor 111, and a database 143 interconnected to one another. Even though only the foregoing components of the server 102 are shown in FIG. 2, in other embodiments, the server 102 may also include other suitable hardware/software components. The network interface 112 can include a network adapter, a wireless network interface controller, and/or other suitable hardware/software configured to connect the server 102 to the client devices 107 (FIG. 1) via the network 108 or other suitable networks. The database 143 can include magnetic disk storage media, optical storage media, flash memory drives, and/or other suitable persistent computer readable storage media excluding propagated signals. The database 143 can be configured to store records of session data 141 for the configured network sessions. The session data 141 may be stored as WebSQL, IndexDB, and/or other suitable types of data records.

The server processor 111 can include a session module 125. In certain embodiments, the session module 125 may be implemented as an application-specific integrated circuit or other suitable types of hardware. In other embodiments, the session module 125 may be implemented as a computer program, procedure, or process written as source code in C, C++, Java, and/or other suitable programming languages. The computer program, procedure, or process may be compiled into object or machine code and presented for execution by the server processor 111. In further embodiments, the session module 125 may be implemented as a combination of hardware and software or as other suitable hardware/software components.

The session module 125 can be configured to establish, update, and/or demolish a network session between a first client device and a second client device interconnected to each other by a computer network via SIP or other suitable protocols. For example, during configuration of a network session, at least one attribute of the configured network session may be negotiated and/or otherwise determined in an encrypted manner. For instance, session attributes are typically included in an encrypted payload of an SIP signaling packet. As a result, network elements 113 (FIG. 1) of the network 108 (FIG. 1) are “blinded” with respect to the configured network session. To “enlighten” the network management system 104 (FIG. 1), the session module 125 can be configured to transmit one or more of the encrypted attributes of the configured network session to the network management system 104 for collecting information from one or more of the network elements 113 during the network session.

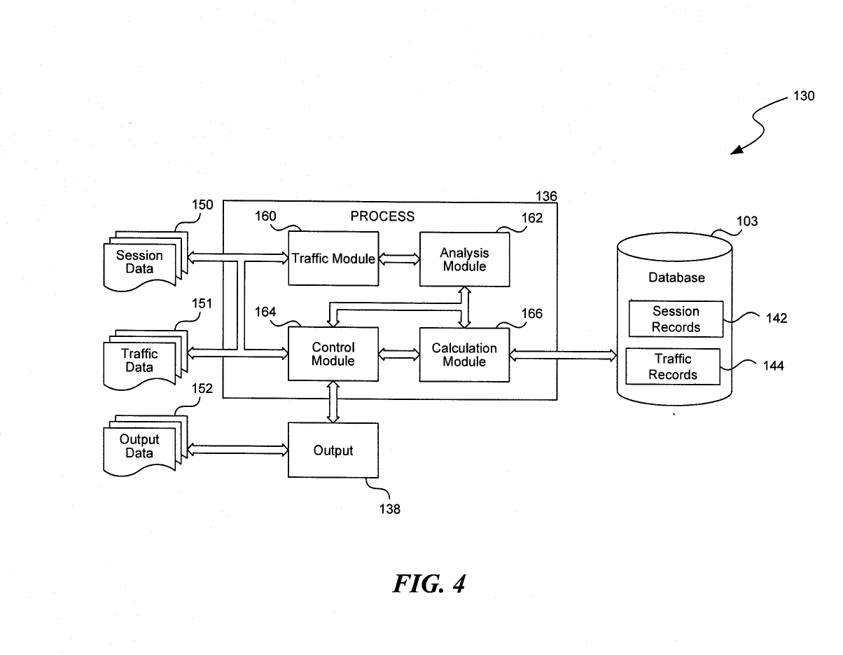

FIG. 3 is a block diagram showing computing components suitable for the network management system 104 of FIG. 1 in accordance with embodiments of the present technology. As shown in FIG. 3, the input component 132 may accept session attributes 150, e.g., from the server 102 (FIG. 1) and network information 151, e.g., from the network elements 113 (FIG. 1), and communicates the accepted information to other components for further processing. The database component 134 organizes records, including session records 142 and traffic records 144, and facilitates storing and retrieving of these records to and from the database 103. Any type of database organization may be utilized, including a flat file system, hierarchical database, relational database, or distributed database, such as provided by a database vendor such as the Microsoft Corporation, Redmond, Wash. The process component 136 analyzes the network information 151 based on the received session attributes 150, and the output component 138 generates output data 152 based on the analyzed network information 151. Embodiments of the process component 136 are described in more detail below with reference to FIG. 4.

FIG. 4 is a block diagram showing software modules 130 suitable for the process component 136 in FIG. 3 in accordance with embodiments of the present technology. As shown in FIG. 4, the process component 136 can include a traffic module 160, an analysis module 162, a control module 164, and a calculation module 166 interconnected with one other. Each module may be a computer program, procedure, or routine written as source code in a conventional programming language, or one or more modules may be hardware modules.

The traffic module 160 is configured to collect and analyze communication traffic data 150. For example, the traffic module 160 may monitor communication traffic in SNMP or other suitable protocols and identify configuration and/or operation parameters for each of the network elements 113 (FIG. 1). The identified parameters may then be converted into traffic records 144 and/or other suitable data stored in the database 103. The traffic module 160 may have comparison, character parsing, or other suitable routines.

The analysis module 162 may be configured to analyze the identified parameters from the network elements 113 and to determine a potential cause for a performance degradation for a network session. For example, in one embodiment, the analysis module 162 is configured to correlate the collected configuration or operation parameters to the performance degradation based on a timestamp of the performance degradation and the timestamps of the collected configuration or operation parameters. In other embodiments, the analysis module 162 may correlate the collected configuration and/or operation parameters with the performance degradation in other suitable manners. The analysis module 162 can then supply the analysis results to the calculation module 166 and/or control module 164 for further processing.

The calculation module 166 can include counters, timers, and/or other suitable accumulation routines configured to perform various types of calculations to facilitate operation of other modules. For example, in one embodiment, the calculation module 166 may include a counter configured to track a number of established network sessions. In another example, the calculation module 166 may include routines for performing time averaging, window averaging, filtering, and/or other suitable operations.

The control module 164 may be configured to monitor and/or potential cause of performance degradation based on inputs from the analysis module 162, the calculation module 166, or other input 154 (e.g., offline manual input). For example, in certain embodiments, the control module 164 can include comparison routines configured to compare at least one the following parameters to a corresponding threshold:
a packet loss rate
a bandwidth used
a throughput
a goodput

In other embodiments, the control module 164 may include other suitable routines. If any of the comparisons indicate that the corresponding threshold has been exceeded, the control module 164 can indicate to the output component 138 that a potential cause exists in the network 108 (FIG. 1), and/or can perform other suitable operations.

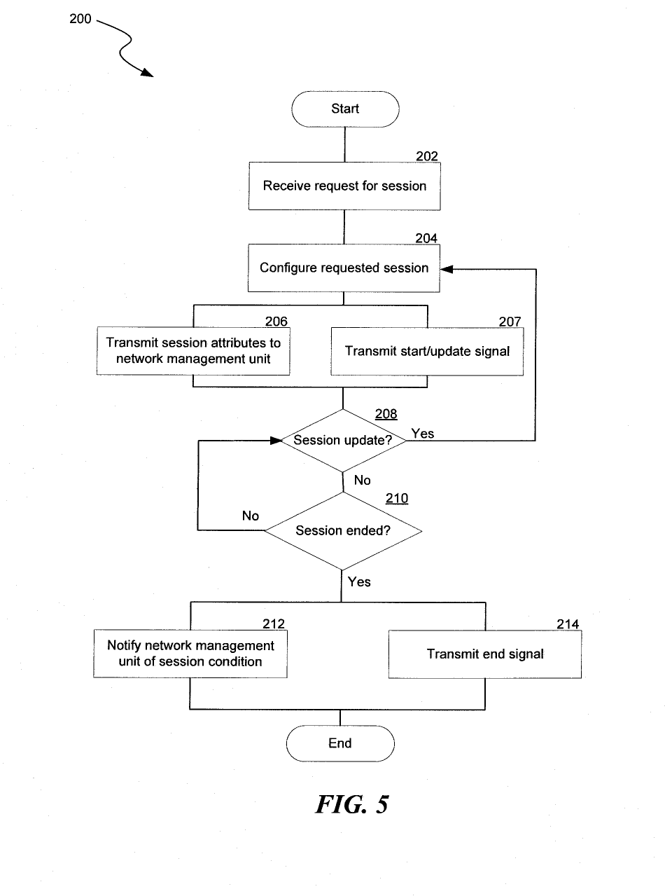

FIG. 5 is a flow diagram illustrating a process 200 for monitoring a computer network in accordance with embodiments of the present technology. Even though the process 200 is described below with reference to the computing framework 100 of FIGS. 1 and the software components/modules of FIGS. 2-4, the method 200 may also be applied in other systems with additional or different hardware and/or software components.

As shown in FIG. 5, the process 200 includes a block 202 of receiving request for a network session from, for example, the client devices 107 (FIG. 1). In response to the received request, the process 200 includes configuring the requested network session at block 204. In one embodiment, the requested network session may be configured by the server 102 (FIG. 1) following the SIP protocol. Thus, the server 102 can signal the client devices 107 with signaling packets having encrypted payloads containing session attributes. In other embodiments, the requested network session may be configured in other suitable manners.

The process 200 then includes a block 206 of transmitting at least one of the session attributes to the network management system 104 (FIG. 1), which can construct a network route 116 (FIG. 1) for the configured network session using IGP or other suitable protocols. The process 200 then includes sending a start signal to the network management system 104 indicating the start of the network session at block 207. Even though blocks 206 and 207 are shown as parallel to each other, in other embodiments, blocks 206 and 207 may be performed in sequence or in other suitable manners.

The process 200 can then include monitoring the network session for updates at block 208. If an update is detected (e.g., a user 101 has added voice, video, data, or other modes of communication to the network session), the process reverts to block 204 to configure a new network session for the update; otherwise, the process proceeds to determining if the network session has ended at block 210. If the network session is still active, the process 200 reverts to monitoring updates at block 208; otherwise, the process proceeds to block 212 for transmitting to the network management system 104 an end signal indicating that the session has ended at block 214.

The process 200 also include notifying the network management system 104 session conditions at block 212. The session conditions can include a good session indication, a bad session indication, a session error indication, and/or other suitable indications along with at least one of the notification items discussed above with reference to FIG. 1.

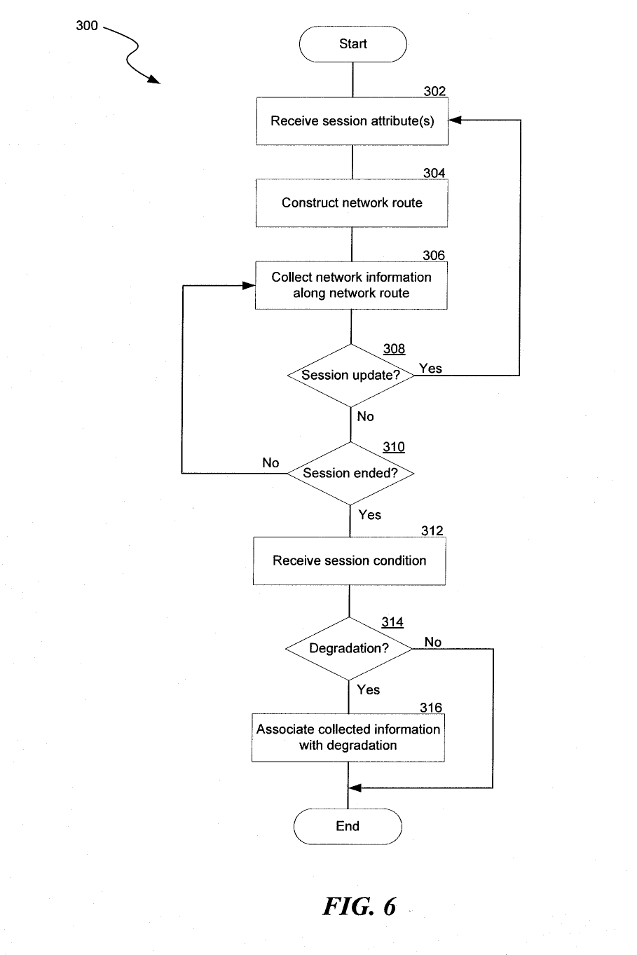

FIG. 6 is a flow diagram illustrating a process 300 for performing diagnostics in a computer network in accordance with embodiments of the present technology. As shown in FIG. 6, the process 300 includes receiving at least one of session attributes from, e.g., the server 102 (FIG. 1) at block 302. Based on the received session attributes, the process 300 includes constructing a network route for the network session at block 304. The process 300 then includes monitoring for a start signal from the server 102 indicating a start of the network session and collecting network information along the constructed network route at block 306.

The process 300 also include monitoring for an session update signal from the server 102 at block 308. If an update is indicated, the process 300 reverts to block 302 for receiving a new set of session attributes for the updated session; otherwise, the process 300 proceeds to block 310 for determining if the network session has ended. If the network session has not ended, the process 300 reverts to block 306 to continue collecting network information along the network route; otherwise, the process 300 proceeds to block 312 for receiving session condition from the server 102.

The process 300 then includes determining if a performance degradation is indicated at block 314. If a performance degradation is indicated, the process 300 proceeds to block 316 for associating collected network information with the performance degradation, as discussed above with reference to FIGS. 3 and 4. If a performance degradation is not indicated, the process ends.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/We claim:

1. A method for network monitoring and diagnostics in a computer network, the method comprising:
signaling to configure a network session between a first client device and a second client device interconnected to each other by the computer network, the configured network session having one or more attributes encrypted during the signaling; and
transmitting one or more of the attributes of the configured network session to a network management system in a decrypted form for collecting information from one or more network elements connecting the first client device to the second client device during the network session.

2. The method of claim 1 wherein configuring the network session includes determining at least one of network addresses of the first and second client devices, a session identifier, a protocol of the session, source and destination transport ports, a media type of the network session, a codec, or a bandwidth estimation of the network session.

3. The method of claim 1 wherein configuring the network session includes transmitting one or more signaling packets between the first and second client devices, the one or more signaling packets having an encrypted payload containing at least one of network addresses of the first and second client devices, a session identifier, a protocol of the session, source and destination transport ports, a media type of the network session, a codec, or a bandwidth estimation of the network session.

4. The method of claim 1 wherein:
configuring the network session includes determining at least one of network addresses of the first and second client devices, a session identifier, a protocol of the session, source and destination transport ports, a media type of the network session, a codec, or a bandwidth estimation of the network session, at least one of which is encrypted; and
transmitting one or more of the attributes includes transmitting the one or more of the determined network addresses of the first and second client devices, session identifier, protocol of the session, source and destination transport ports, media type of the network session, codec, or bandwidth estimation of the network session to the network management system.

5. The method of claim 2 wherein:
configuring the network session includes transmitting one or more signaling packets between the first and second client devices, the one or more signaling packets having an encrypted payload containing at least one of network addresses of the first and second client devices, a session identifier, a protocol of the session, source and destination transport ports, a media type of the network session, a codec, or a bandwidth estimation of the network session; and
transmitting one or more of the attributes includes transmitting, in a decrypted form, the one or more of the determined network addresses of the first and second client devices, session identifier, protocol of the session, source and destination transport ports, media type of the network session, codec, or bandwidth estimation of the network session to the network management system.

6. The method of claim 1, further comprising notifying the network management system of at least one of a start, an update, or an end of the network session.

7. The method of claim 1 wherein:
the network session includes at least a voice session, a video session, or an application sharing session; and
the method further includes notifying the network management system of a performance degradation in the network session and at least one of
a delay value;
a jitter value;
a packet loss value; or
a healer ratio value of the network session.

8. A method for network monitoring and diagnostics in a computer network, the method comprising:
receiving one or more of the attributes of a configured network session between a first client device and a second client device, at least one of the attributes is encrypted during configuration of the network session;
configuring a network path that connects the first client device to the second client device based on the received one or more of the attributes of the configured network session, the network path having one or more network elements; and
collecting information from the one or more network elements along the network path during the network session.

9. The method of claim 8, further comprising associating the collected information with the network session based on the received one or more of the attributes of the network session.

10. The method of claim 8 wherein receiving one or more of the attributes includes receiving at least one of network addresses of the first and second client devices, a session identifier, a protocol of the session, source and destination transport ports, a media type of the network session, a codec, or a bandwidth estimation of the network session.

11. The method of claim 8 wherein collecting information includes collecting and storing at least one of a configuration or operation parameter of the one or more network elements with a corresponding timestamp.

12. The method of claim 8 wherein collecting information includes collecting at least one of a traffic throughput, a class of service, or a value of dropped packet at each of the one or more network elements with a corresponding timestamp.

13. The method of claim 8 wherein collecting information includes collecting at least one of a traffic throughput, a class of service, or a value of dropped packet at each of the one or more network elements and storing the collected at least one of traffic throughput, class of service, or value of dropped packet at each of the one or more network elements with a timestamp.

14. The method of claim 8, further comprising designating at least some of the collected information from the one or more network elements as data traffic for the network session, at least a portion of the data traffic being encrypted.

15. The method of claim 8 wherein:
collecting information includes collecting and storing at least one of a configuration or operation parameter of the one or more network elements with a corresponding timestamp;
the method further includes receiving a notification indicating a performance degradation of the network session, the performance degradation having an error timestamp; and
associating the collected information includes correlating the collected configuration or operation parameter to the received notification indicating the performance degradation in the network session based on the error timestamp and the timestamps of the configuration or operation parameter.

16. The method of claim 8 wherein:
collecting information includes collecting and storing at least one of a configuration or operation parameter of the one or more network elements with a corresponding timestamp;
the method further includes receiving a notification indicating a performance degradation of the network session, the performance degradation having an error timestamp;
associating the collected information includes, based on the error timestamp and the timestamps of the configuration or operation parameter, comparing the collected configuration or operation parameter to a corresponding range; and
indicating a network error if a value of the collected configuration or operation parameter is not within the corresponding range.

17. A computer system for network monitoring and diagnostics in a computer network, the method comprising:
a server configured to establish a network session between a first client device and a second client device interconnected to each other by the computer network, the configured network session having one or more attributes encrypted during establishing the network session;
a network management system coupled to the server, the network management system being configured to
receive one or more of the attributes of the established network session between the first client device and the second client device;
determine a network path connecting the first client device to the second client device based on the received one or more of the attributes of the network session, the network path having one or more network elements interconnecting the first and second client devices;
collect configuration and/or operation information from the one or more network elements during the network session; and
associate the collected configuration and/or operation information with the network session based on the received one or more of the attributes of the network session.

18. The computer system of claim 17 wherein the network management system is configured to receive at least one of network addresses of the first and second client devices, a session identifier, a protocol of the session, source and destination transport ports, a media type of the network session, a codec, or a bandwidth estimation of the network session from the server.

19. The computer system of claim 17 wherein:
the server is also configured to transmit a notification to the network management system, the notification indicating a performance degradation of the network session, the performance degradation having an error timestamp;
the network management system is configured to:
collect and store at least one of a configuration or operation parameter of the one or more network elements with a corresponding timestamp; and
correlate the collected configuration or operation parameter to the received notification indicating the performance degradation in the network session based on the error timestamp and the timestamps of the configuration or operation parameter.

20. The computer system of claim 17 wherein:
the server is also configured to transmit a notification to the network management system, the notification indicating a performance degradation of the network session, the performance degradation having an error timestamp;
the network management system is configured to:
collect and store at least one of a configuration or operation parameter of the one or more network elements with a corresponding timestamp;
based on the error timestamp and the timestamps of the configuration or operation parameter, compare the collected configuration or operation parameter to a corresponding range; and
indicate a network error if a value of the collected configuration or operation parameter is not within the corresponding range.
